(19) United States
(12) Patent Application Publication
(10) Pub. No.: US 2008/0154643 A1
(43) Pub. Date: Jun. 26, 2008

(54) System and Method for Patient Management of Personal Health

(76) Inventor: Mauricio A. Leon, San Diego, CA (US)

Correspondence Address: Mauricio A. Leon;e-healthcommunities, 9658 Deer Trail Way, San Diego, CA, 92127, US

(21) Appl. No.: 11/678,584

(22) Filed: Feb. 24, 2007

Related U.S. Application Data
(60) Provisional application No. 60/767,059, filed on Mar. 1, 2006.
(60) Provisional application No. 60/767,411, filed on Mar. 27, 2006.

(51) Int. Cl. G06Q 50/00

(52) U.S. Cl. 705/3

(57) ABSTRACT

The present invention relates to systems for enabling patients to maintain better health information and take greater responsibility and control of the decisions affecting their health. More specifically, the present invention relates to automated systems and methods that enable patients to more effectively take proactive and successful actions to preserve their health and to manage disease.

### Related Applications

This non-provisional application claims priority to U.S. Provisional Application Ser. No. 60/767059, Entitled “System and Method for Patient Management of Personal Health” by Mauricio Leon, filed on Mar. 1, 2006, incorporated herein by reference under the benefit of U.S.C. 119(e). This non-provisional application also claims priority to U.S. Provisional Application Ser. No. 60/767411, Entitled “System and Method for Patient Management of Prescription Information” by Mauricio Leon, filed on Mar. 27, 2006, incorporated herein by reference under the benefit of U.S.C. 119(e).

### FIELD OF INVENTION

The present invention relates to systems for helping to assure that patients comply with their written prescriptions.

### BACKGROUND OF THE INVENTION

Today, the overall preservation of health and recovery from disease is a complex and fragmented mélange of efforts. Weaknesses of the current health system are found in many areas including deficient communications, poor storage and management of health information and knowledge, sub-optimal decision-making, and inconsistent implementation of health decisions, to mention just a few.

The health system is “designed” to operate around the concept of medical records, and yet those records are fragmented, incomplete, non-audited and generally stored with each of the health providers. Since a typical patient obtains health care from a number of different providers sometimes scattered across the country, likewise the medical records are also scattered. If a patient has a health related issue, the healthcare practitioner generally will not have access to all the relevant records without an extraordinarily organized and proactive patient.

However, even if a patient could have instant access to all the records, their usefulness to a provider may be limited. A given set of records is not health knowledge; it is mostly “raw data” and becomes massive in quantity and less reliable with time. It is hardly practical to imagine a practitioner digging through the complete set of medical records for a patient every time there is a health issue.

Finally, a health issue may require taking multiple synergistic actions over a period of time that are meant to improve a given condition. This puts a big burden on a patient who is busy with many aspects of life (raising families, developing careers, etc.) that makes focusing on personal health care difficult. What is needed is a way of making the management of health more effective while reducing burdens on physicians and patients.

### BRIEF DESCRIPTION OF THE DRAWINGS

FIG. 1 is a block diagram representation of an exemplary information technology ecosystem containing the health service system of the present invention.

FIG. 2 is a block diagram representation of an exemplary information technology ecosystem containing the health service system of the present invention.

FIG. 3 is a block diagram representation of a patient subsystem.

FIG. 4 is a block diagram representation of an agent subsystem.

FIG. 5 is a block diagram representation of a community subsystem.

FIG. 6 is a flow chart representation of a method of engaging and terminating mandatory or non-elective agents of the present invention.

FIG. 7 is a flow chart representation of a method engaging an elective agent.

FIG. 8 is a flow chart representation of a method of operating an agent.

FIG. 9 is a flow chart representation of a method of utilizing the present invention to realize the goal of having a consultation with a medical practitioner.

FIG. 10 is a flow chart representation of an optimal method of utilizing an agent to obtain a prescription. Alternatively, the essential method of FIG. 10 can be utilized to obtain other medical or dental or optical related services or products.

FIG. 11 is a flow chart representation of a method of managing immunizations.

FIG. 12 is a flow chart representation of a method of real time disease tracking.

FIG. 13 is a flow chart representation of a method of obtaining a health related product or service. The method of FIG. 13 can be utilized as a portion of the method of FIG. 10.

FIG. 14 is a flow chart representation of a method utilized by a patient to establish and define an account with a community subsystem of the present invention.

FIG. 15 is a process flow diagram depicting a method whereby a customer such as a pharmaceutical company establishes a “community” within a community subsystem of the present invention.

FIG. 16 is a process flow diagram whereby a customer such as a pharmaceutical company manages a “community” within a community subsystem of the present invention.

FIG. 17 is an illustration depicting a relationship between populations of patients within the health service system relative to community membership criteria.

FIG. 18 is a flow chart representation of a process wherein the health service system of the present invention performs an audit of a health service.

FIG. 19 is a flow chart representation of a process wherein a health care provider places a “hold” on medical records.

FIG. 20 is a flow chart representation of a process wherein the records held according to FIG. 19 are released.

FIG. 21 is a flow chart representation of a patient workflow associated with a “lease a practice” implementation of the health service system of the present invention.

FIG. 22 is a process flow representation of a way a patient can receive prescription information from a pharmacy and/or gain access to health service system 4.

FIG. 23 is a process flow representation of a way in which prescription related information can be transferred from a pharmacy system to a patient system and/or wherein the patient system may gain access to health service system 4.

### DETAILED DESCRIPTION OF THE PREFERRED EMBODIMENTS

The present invention concerns a health service system configured to store patient health facts, to use these “facts” to generate patient health knowledge, and to use these and other resources to assist patients to accomplish health-related goals. The health service system includes an IT (information technology) system that is coupled to a network that is in communication with patient systems, information clients, pharmacy systems, healthcare provider systems, and other IT systems.

For each patient, the health service system includes an archival system that stores patient facts as well as derived knowledge. Patient knowledge differs from medical facts in that it is something that can be inferred from these facts and other sources of information for a particular patient. For example, if a patient discovers that she feels dizzy every time she eats certain foods, that discovery is patient knowledge. In another scenario, the current invention may find an association between patient reported allergy symptoms and changes in home temperature, humidity, or other environmental factors.

These discoveries may or may not be inferred from conventional medical records, since a health care provider may not have recorded the observations or may not even be looking for such associations. Thus, while conventional health records can be thought mostly as containing the “raw data” that is recorded by healthcare providers, “patient knowledge” is the information that is particularly useful or “actionable”. By actionable, we refer to knowledge that the patient or the provider can use to make decisions set particular health related goals.

These goals can be short term or long term, single action focused or ongoing. And they can be nested into large hierarchies. For example the highest-level goal for a patient: maintain health and cure disease, is in turn made of a myriad of simpler sub goals.

To assist the patient to accomplish those goals, the health service system includes an agent subsystem that is configured to initiate patient health goals and to follow through to make sure those goals are accomplished. These goals can include adding to patient knowledge or carrying out actions to advance health of the patient.

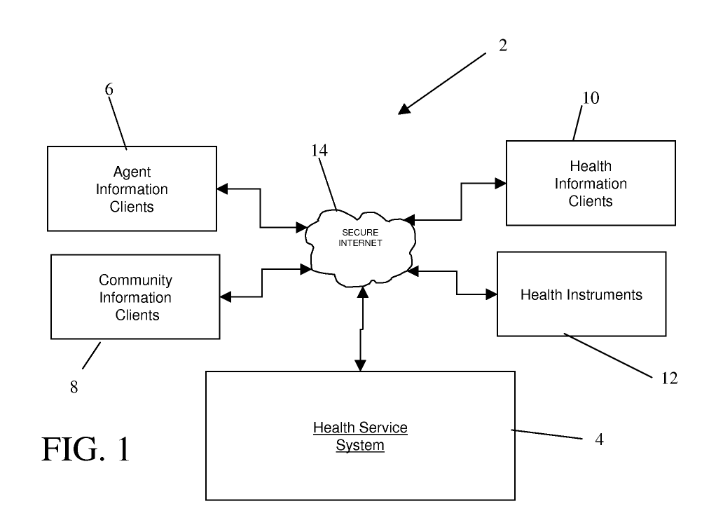

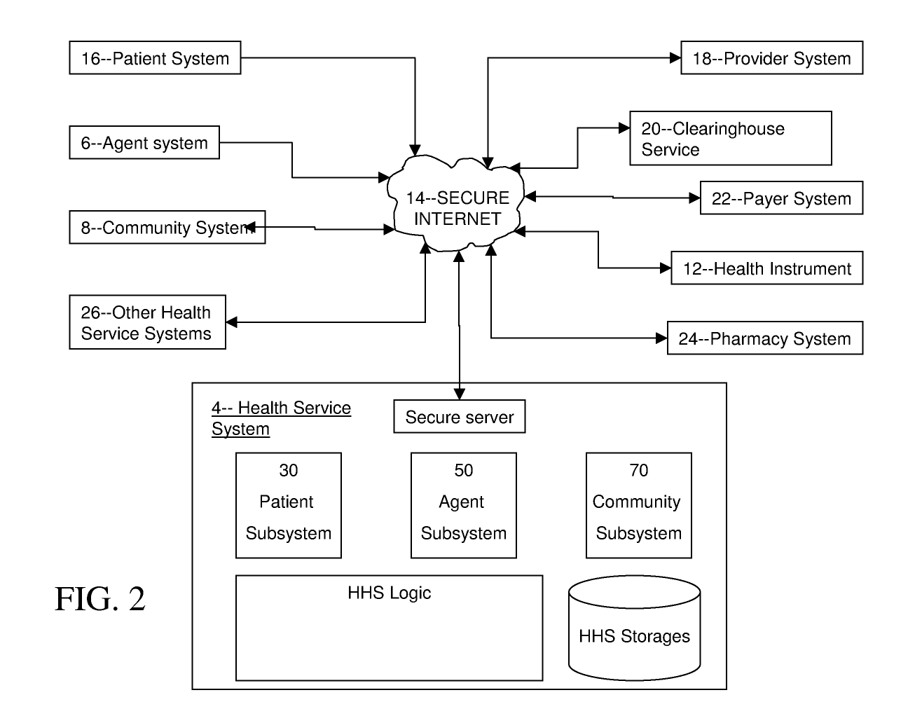

An exemplary “network ecosystem” 2 containing the health service system 4 of the present invention is depicted with respect to FIGS. 1 and 2. According to FIG. 1, health service system 4 is coupled to a number of sources of information including agent information clients 6, community information clients 8, health information clients 10, and health instruments 12 via the Internet 14.

An exemplary embodiment of health service system 4 is depicted in FIG. 2. In addition to the aforementioned information sources (elements 6, 8, 10, 12) discussed with respect to FIG. 1, health service system is coupled to a patient system 16, a healthcare provider system 18, a clearinghouse system 20, a payer system 22, a pharmacy system 24, and potentially other health service systems 26. Each of these systems 16-26 are IT (information technology) systems that may interact with each other and/or health service system 4.

Health Service System 4: Depicted in FIG. 2 is an exemplary embodiment of health service system 4. Health service system 4 is an IT (information technology) system that includes a patient subsystem 30, an agent subsystem 50, and a community subsystem 70. Patient subsystem 30 is a component of the health service system 4 that is under the control of the patient via patient system 16. It stores patient facts (traditional medical records are a sub-set of possible patient facts), patient knowledge, and includes management software to enable patient system 30 to interact with and control operations related to agent subsystem 50 and community subsystem 70.

Agent subsystem 50 includes software agents that automate the activity of a patient or a community in pursuing healthcare related goals.

Community subsystem 70 is configured to couple patients and other entities into “communities” from which information related to and useful to two or more patients or organizations can be obtained.

Patient system 16: The patient system 16 is any device utilized by the patient to communicate with health service system 4 via patient subsystem 30. It can include a personal computer, a phone, a PDA, or other devices.

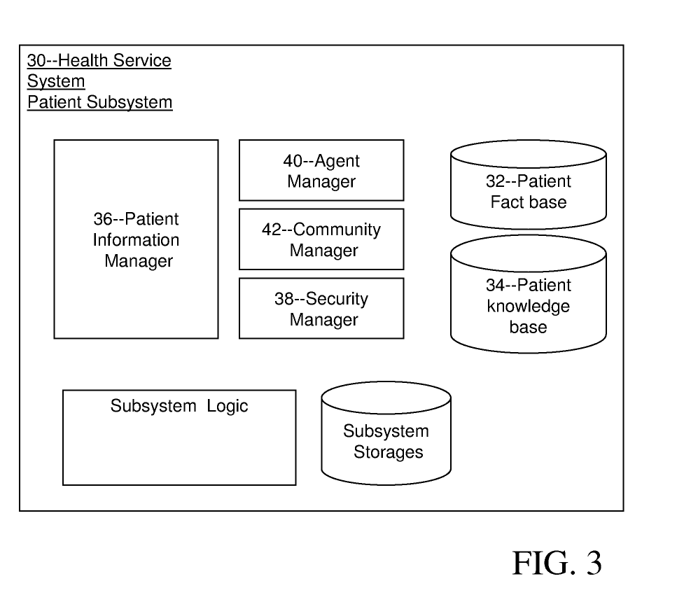

An exemplary embodiment of patient subsystem 30 is depicted in block diagram form in FIG. 3. Patient subsystem 30 includes patient fact base 32 that stores medical or health related facts for the patient. Patient fact base 32 may be updated, for example, by patient system 16, provider system 18, and health instrument 12. Patient fact base 32 contains all information traditionally stored in health records such as results of diagnostic tests, records of visits to doctors, dentists, optometrists, chiropractors, etc. Patient fact base 32 can also store information recorded by the patient such as blood pressure, heart rates, etc. The patient fact base can also store any new type of data or information associated with the patient's body or health. For example it could store continuous patient video or audio signals or it can store live information from patient cell cultures.

Patient subsystem 30 also includes patient knowledge base 34. Patient knowledge base 34 stores knowledge that may be inferred from facts in fact base 32 or inferred from a number of sources of information including fact base 32. We refer to the knowledge in knowledge base 34 as “health knowledge information” because it is information that is more actionable or usable by the patient compared to the facts archived in fact base 32. Some examples of “health knowledge information” that may be stored in patient knowledge base 34 include the following:
Allergies models
   Personalized model associating air quality and other factors with the onset and severity of allergy symptoms
Therapy effectiveness models
   Personalized model associating patient bio-markers with effectiveness of actual or future therapies
Side effects or adverse effect models
   Personalized model associating patient bio-markers with side or adverse effects of actual or future therapies
Physiologic models
   Personalized model associating or explaining the behavior or responses of any body system or subsystem. For example a model that associates exercise and variations in cardiovascular parameters.
Personalized disease models that explain or anticipate disease or changes during a pre-disease status. Considering today's morbidity indicators, these models may preferably concern:
   Cardiac disease
   Cancer and pre-cancer status
   Susceptibility to common colds or the flu
   Dental diseases
   Etc

Patient information manager 36 assures proper archival of the health facts in fact base 32 and knowledge base 34. Security manager 38 assures secure record keeping and transmission of patient information.

Agent manager 40 manages the interface between patient system 16 and agent subsystem 50. This includes enabling the patient to access agents, activate agents, track the progress of agents, modify the behavior or specific goals of agents, and suspend, resume, or cancel agents. The agent management system also controls the interactions between agents preventing duplicative or inconsistent tasks.

Community manager 42 manages the interface between patient system 16 and community subsystem 70. It may also manage the information passed between the patient system and different communities of people or entities.

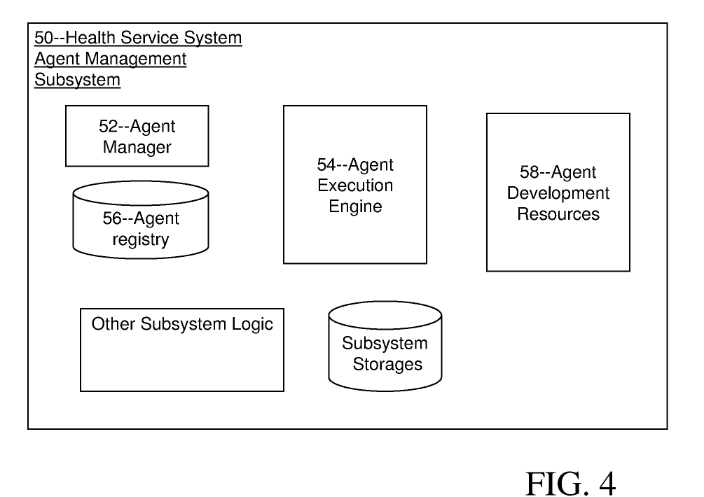

An exemplary embodiment of agent management subsystem 50 is depicted with respect to FIG. 4. Agent management subsystem 50 includes various components that enable the activation and use of health agents. A health agent is a software module that operates in an effort to assure completion of a defined goal for the patient. Examples of higher-level goals might include:
Having (not just scheduling) a doctor appointment
Eradicating an infection
Lowering high blood pressure
Obtaining a health opinion from a local, remote, or anonymous provider
Retrieving and synthesizing the health status and trends of an entire community
Controlling compliance in a clinical trial
Early discovery of prostrate cancer
Vigilance for a new born
Detecting early side effects of medications
Detecting early stages of processes that affect the health of the community

Agent management subsystem 50 includes agent manager 52, agent execution engine 54, agent registry 56, and agent development resources 58. Agent manager 52 controls functions related to agents such as uploading an agent to a client user, downloading an agent, “publishing” an agent so that it becomes available to users, evaluation of agent utilization and performance, submitting an agent for execution, and submitting a signal for aborting or suspending an agent.

Agent execution engine 54 runs an agent to enable it to facilitate and/or accomplish a goal. Agent registry 56 tracks what agents are, have been, or will be available. Agent development resources 58 include tools and components for enabling the creation and improvement of agents.

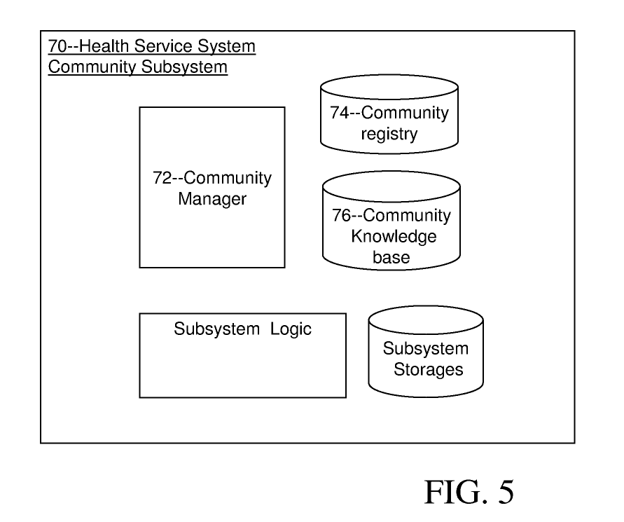

An exemplary embodiment of community subsystem 70 is depicted with respect to FIG. 5. Community subsystem 70 provides a functional connection between the patient and related communities. A community is a group of people or entities whose association can be defined in various ways. There are two types of communities—physical and virtual. A virtual community would be a community of people or entities having something in common such as all having a given state or participating in a particular event.

Examples of communities can include:
Physical—People living in a geographical area
Physical—People residing or located in a particular hospital
Virtual—People participating in a particular clinical trial
Virtual—People affected by a particular disease state
Virtual—Community of pregnant women
Hybrid of Virtual and Physical—Community of people having a certain demographic criteria living in a certain geographic region

Community subsystem 70 includes community manager 72, community registry 74, and community knowledge base 76. Community manager 72 controls functions such as creation of a community, termination of a community, storage of the community's “contract” (where applicable), execution of the contract with every community member, and reporting on the status of communities.

Community registry 74 stores a listing of existing, possible future, and past communities. Community knowledge base 76 stores useful information about particular communities. An example of such knowledge might be incidence of a particular flu over a given physical community.

There is a close relation between subsystems 30, 50, and 70. For example, a patient may utilize patient subsystem 30 to select and activate an agent via agent management subsystem 50. That agent may utilize knowledge from community subsystem 70 in order to accomplish a goal for the patient.

There are two types of agents enabled by subsystem 50—mandatory agents and elective agents. Mandatory or non-elective agents are required agents that are automatically engaged when a patient activates an account with health service system 4. Examples include the following:
Agent to enter basic health information
Agent to display or retrieve information
Agent to guarantee that initial set-up with the system is completed
Agent that seeks definition of security preferences

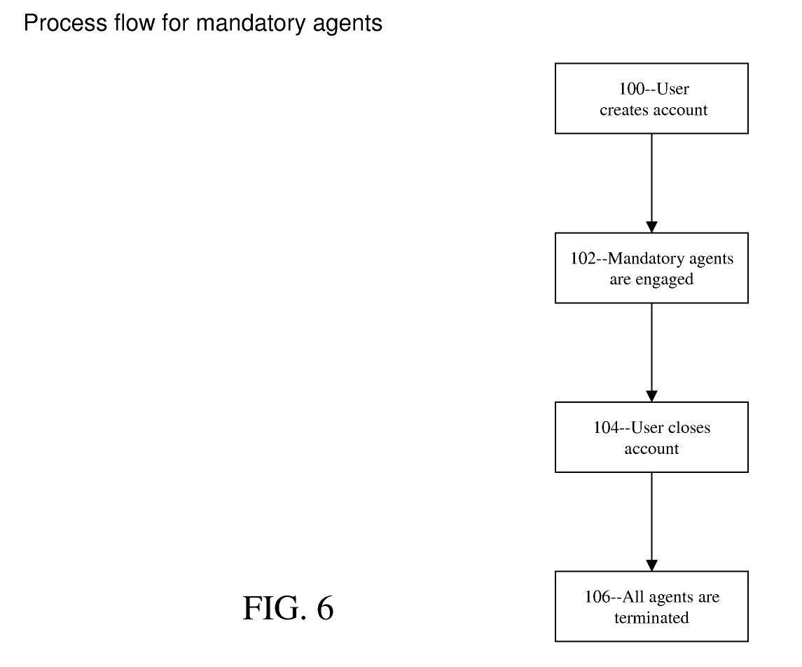

An exemplary process for engaging mandatory agents is depicted with respect to FIG. 6. According to 100, a user or patient creates an account with health service system 4. Creation of the account results in engagement of mandatory agents according to 102. When a user closes an account 104 all agents are automatically terminated according to 106.

Examples of elective agents include:
Immunization agent (goal is to achieve best immunization protection possible)
Prescription savings agent (goal is to minimize the costs of prescriptions)
Health audit agent (goal is to audit medical recommendations, assessments, finings)
Smart scheduling agent (goal is to optimize appointment date and location and to minimize waiting time)

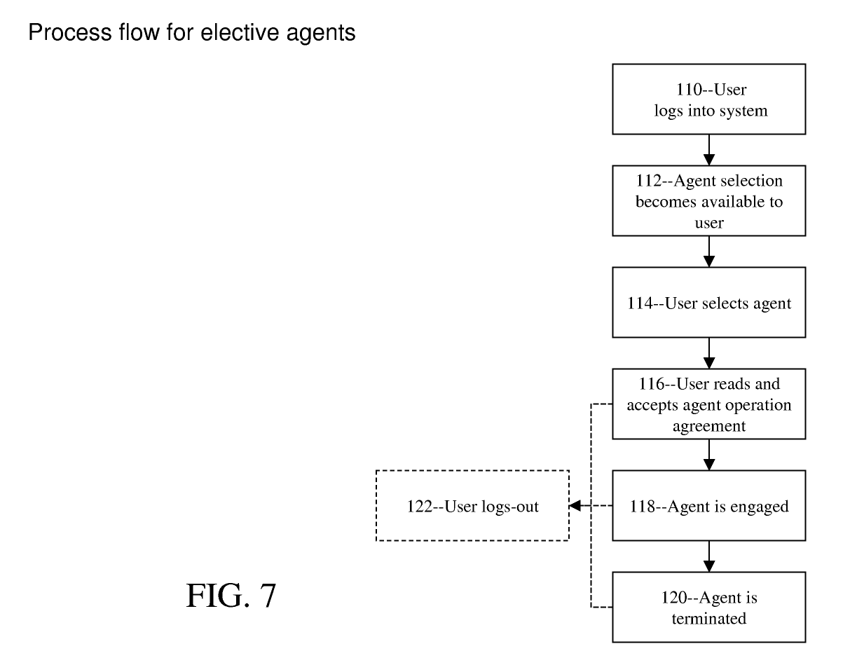

An exemplary process for engaging elective agents is depicted with respect to FIG. 7. According to 110, a user logs into the health service system 4. According to 112, agent manager 40 provides an agent selection for the user. Preferably, agent manager 112 communicates an agent selection to the user via the patient system 16.

According to 114, the patient makes a selection of an agent via agent manager 40. According to 116, agent subsystem provides to the patient an agent operation agreement that is subsequently reviewed and accepted by the user. According to 118, the agent is engaged and begins to pursue a patient related goal.

According to 120 the agent is terminated either by user selection or by attainment of the goal for which the agent was selected. Depending on the type of agent, the time between 118 and 120 could vary considerably. In some cases, the agents' activity may be brief or may continue operating for years in pursuit of a goal or maintenance of a goal.

According to 122 the user logs out. When this happens relative to 116 to 120 depends on the type and duration of the agent as well as user preference.

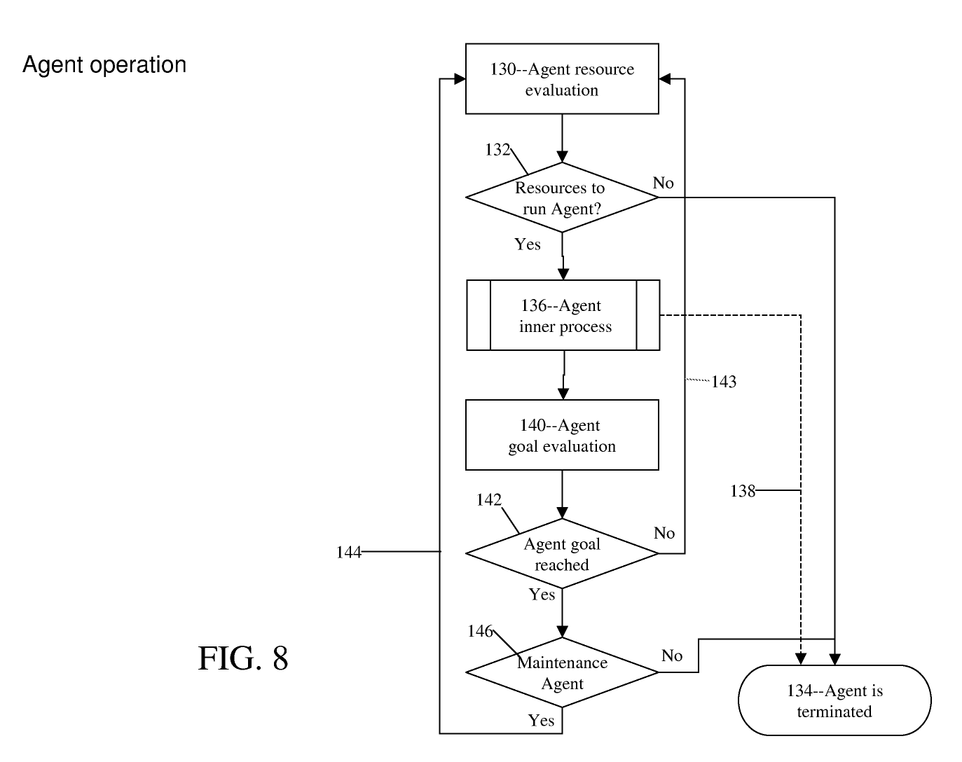

An exemplary operation of an agent is depicted with respect to FIG. 8 in flow chart form. According to 130, computer resources available to the agent are evaluated and a decision is made according to 132. If adequate resources are not available, the agent is terminated according to 134.

If adequate resources are available, then the agent is executed according to 136. Some agents, by their very execution, accomplish their goal and are then terminated according to 138. Other agents, however, require evaluation that ascertains the accomplishment of the intended goal, according to 140 and a consequent decision according to 142.

If the agent goal has been not been reached, then the agent will continue to operate according to 143. If the agent goal is reached, then another factor is considered according to 146. If the agent is a maintenance agent, then it will continue to operate according to 144. If the agent goal is not continuous but is characterized by the realization of a single event, then the agent is terminated according to 134.

A maintenance agent is an agent such as maintenance of an exercise routine or diet that continues on with time, perhaps for the patient's lifetime.

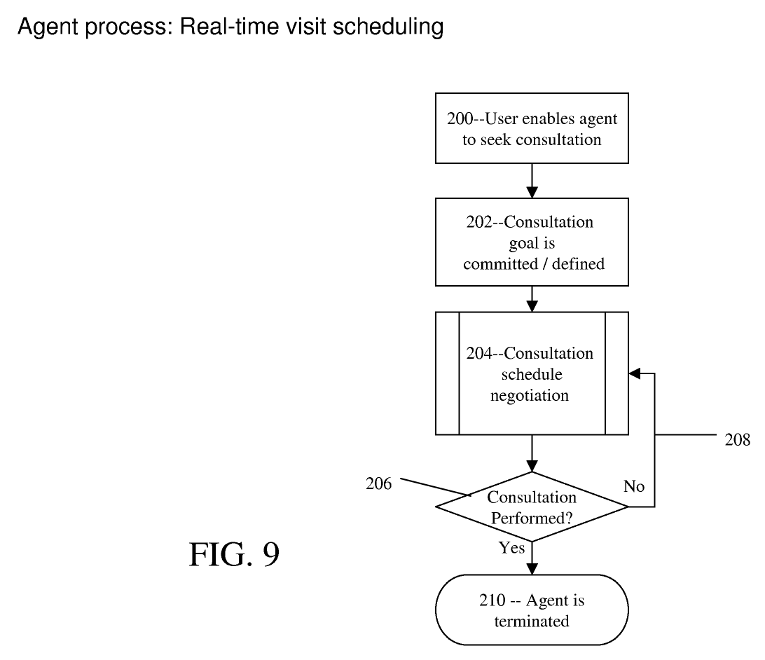

A first example of an agent process is depicted in flow chart form in FIG. 9. The goal of the agent is for the patient to receive consultation from a medical practitioner. According to 200, a user utilizes agent manager 40 to enable an agent that seeks the consultation (such as a doctor visit). According to 202, the patient utilizes an interface provided by agent manager 40 to define the consultation goal.

According to 204, a process takes place whereby the consultation is scheduled. This may include the completion of separate sub-goals intended to schedule appointments and post those appointments on a patient's electronic calendar. According to 206, the health service system seeks verification that the patient has received the consultation. For example, upon completion of the consultation, medical records may be transferred from provider system 18 (the IT system of the healthcare provider that provided the consultation) to the patient fact base 32.

If it is determined that the consultation has not been performed on an earlier scheduled date, then the agent will continue to try to schedule consultation according to 208. If, on the other hand, verification of the consultation is received, then the agent is terminated according to 210.

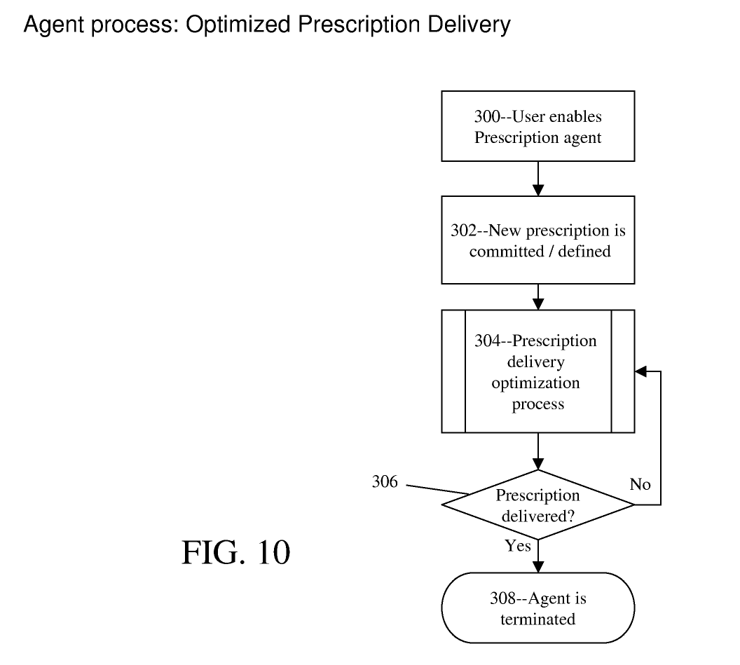

The action of an agent having a goal to optimally procure a prescription for a user is depicted with respect to FIG. 10 in flow chart form. According to 300, a user of health service system 4 utilizes agent manager 40 to enable a prescription agent. According to 302, the user uses agent manager 40 to define the agent—for example, the agent manager may display or otherwise describe a pending prescription on the patient system 16.

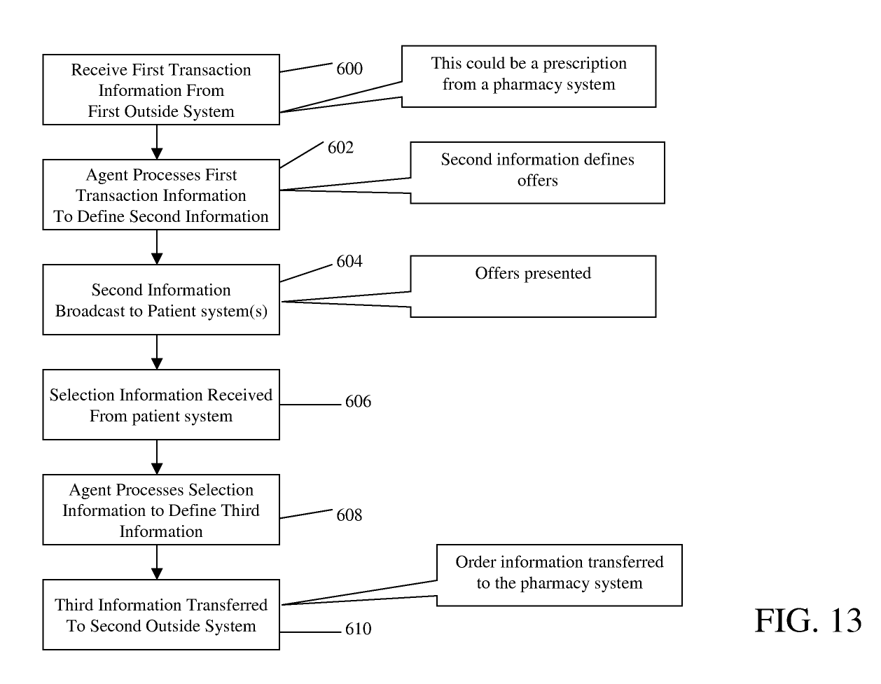

In one embodiment according to 302 the user selects the prescription. According to 304, the prescription delivery agent pursues the goal of an optimal delivery of the prescription to the patient. One process for prescription delivery according to 304 will be discussed with respect to FIG. 13.

According to 306, the agent determines whether or not the prescription has been delivered to the patient. In one embodiment health service system 4 receives information from patient system 16 that confirms receipt of the prescription. If the prescription has been delivered or received by the patient, then this agent is terminated according to 308. If the prescription has still not been delivered, then the process according to 304 continues.

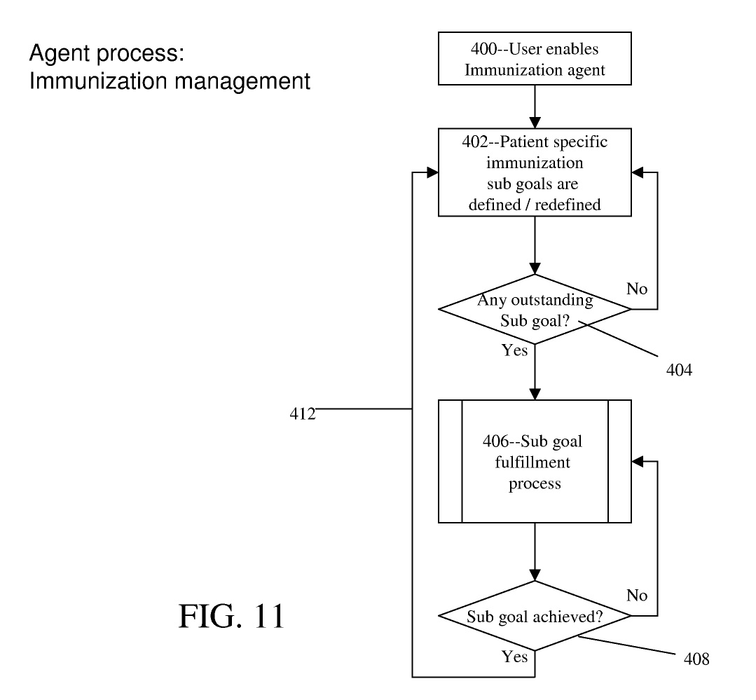

The action of a continuous or maintenance-type agent is depicted in flow chart form with respect to FIG. 11. According to 400, the user utilizes agent manager 40 to enable an immunization agent. According to 402, patient specific immunization sub-goals are defined. An example of the use of this agent may be for a new baby, wherein an immunization objective is desired. The goal is to achieve the best immunity protection considering the child's risk factors. A strategy to satisfy this goal might consist of meeting a certain schedule for the application of a vaccine regimen. Further sub-goals might be to receive certain vaccinations on a certain days.

According to 404, the agent checks to see whether there are any outstanding sub-goals. Examples of sub-goals might be - is there an immunization coming up on a calendar in the near future or is there one that is past due? If not, then the system loops back, with the option of the user updating the sub goals. One reason for such an update might be the existence of a new flu vaccine availability that needs to be considered.

According to 404, if there is an outstanding sub goal, then the system activates a sub goal fulfillment process. This may include further sub-goals such as the creation and management of an appointment to receive an immunization. Step or process 406 may includes steps that are very similar to some of those depicted with respect to FIG. 9 except that a vaccination rather than a consultation is planned.

According to 408, the agent determines whether or not the sub goal has been achieved. If not then the process loops back to 406 according to 410. If the sub-goal has been achieved, then the process loops farther back according to 412. Since this is a maintenance-type of agent, the overall goal is likely to be a lifetime effort to maintain the best immune protection.

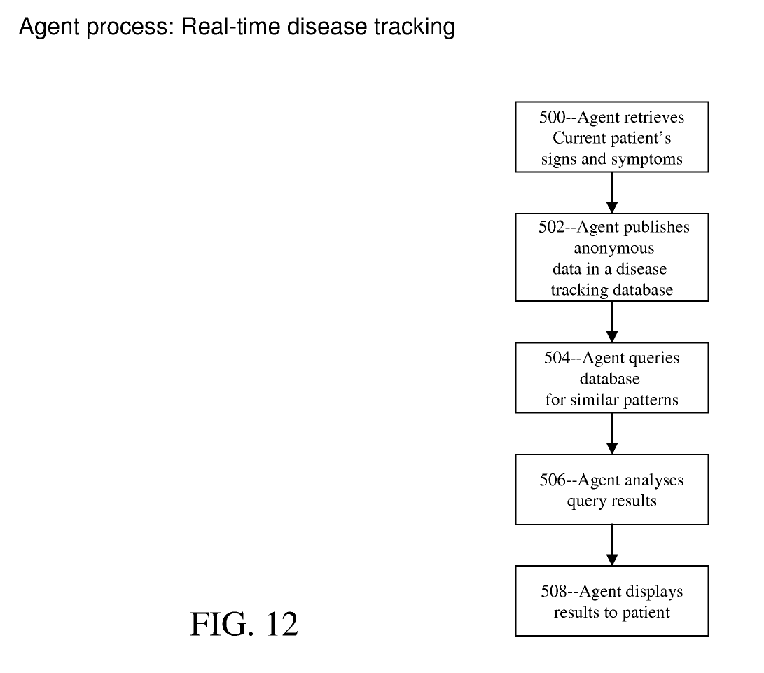

An agent that provides real time illness or disease tracking for a community is depicted with respect to FIG. 12. According to 500, the user utilizes agent manager 40 to input the patient's signs and symptoms related to an illness. According to 502, the agent removes patient identify information and adds information related to the patient's signs and symptoms to the overall community knowledge base 76 that includes information tracking the incidence of an illness.

According to 504, the agent queries the knowledge base for similar signs and symptoms. According to 506, the agent analyzes the query results to determine whether the particular patient's symptoms and signs are related to health events in the broader community. According to 508, the agent displays results of the analysis to the patient.

A process for procuring a health related service or product is depicted with respect to FIG. 13. According to 600, health service system 4 receives first transaction information from an outside system. This could be a prescription or a request for quote for example. This defines a goal for receiving the service or product.

According to 602, the agent processes the first transaction information to define second information. This processing may be based on pre-existing rules that were previously defined by providers or health products or services. Alternatively, processing according to 602 could include sending requests for quote to providers of the health products or services and then receiving quotations or offers back. The quotations are examples of the second information according to 602.

According to 604, health service system 4 broadcasts the second information to patient system(s). Examples of broadcasts could be emails or voice mails that provide the user with choices for receiving the health care products or services.

According to 606, health service system 4 receives selection information from patient system 16 that is indicative of which of the offers to accept. According to 608, the health service system processes the selection information to define third information. This third information may define an order for a health service or product.

According to 610, the third information is transferred to an outside system such as a pharmacy system 24 or another provider of health products or services. Now, referring back to FIG. 10, the steps of FIG. 13 could be substantially contained within 304 of FIG. 10. But the process of FIG. 10 or 13 could apply to various health-related needs, such as any or all of the following:
Medical Products
Medical Services
Dental or Optometry Products or Services
Health Insurance Products
Health consultations

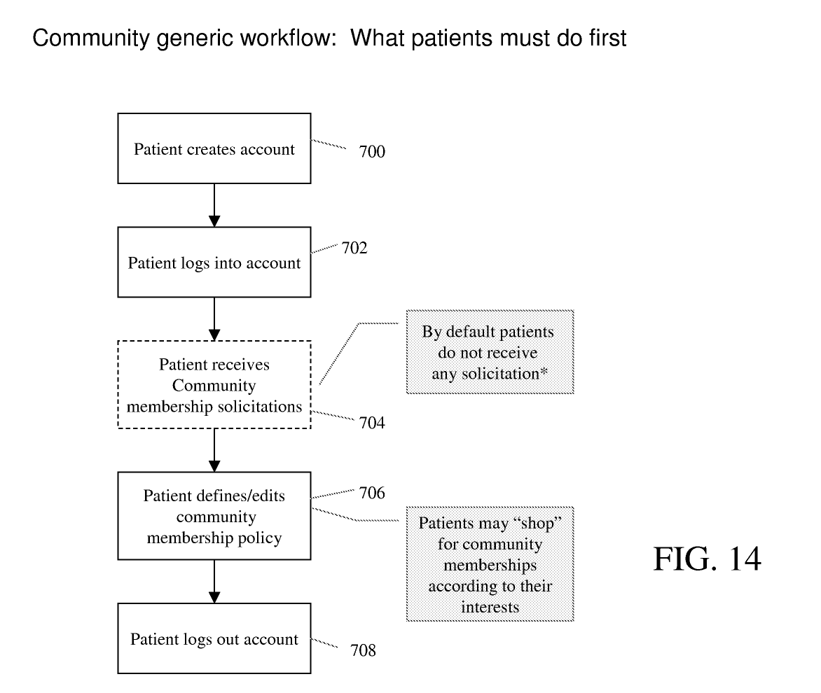

A process by which a user or patient utilizes tools within community manager 42 to set up an account with community subsystem 70 is depicted in flow chart form with respect to FIG. 14. According to 700, the user creates an account with community subsystem 70. Once this account is created, the user logs into the account according to 702. After logging into the account, the user optionally receives community member solicitations according to 704. Examples of community membership solicitations include interest in participation in a clinical trial, enrollment in a myocardial infarction rehabilitation program, community for mass procurement of some products or services, etc. In a preferred embodiment, the user elects whether to receive the solicitations in the first place. According to 706, the user defines and edits the community membership policy. According to 708 the user logs out.

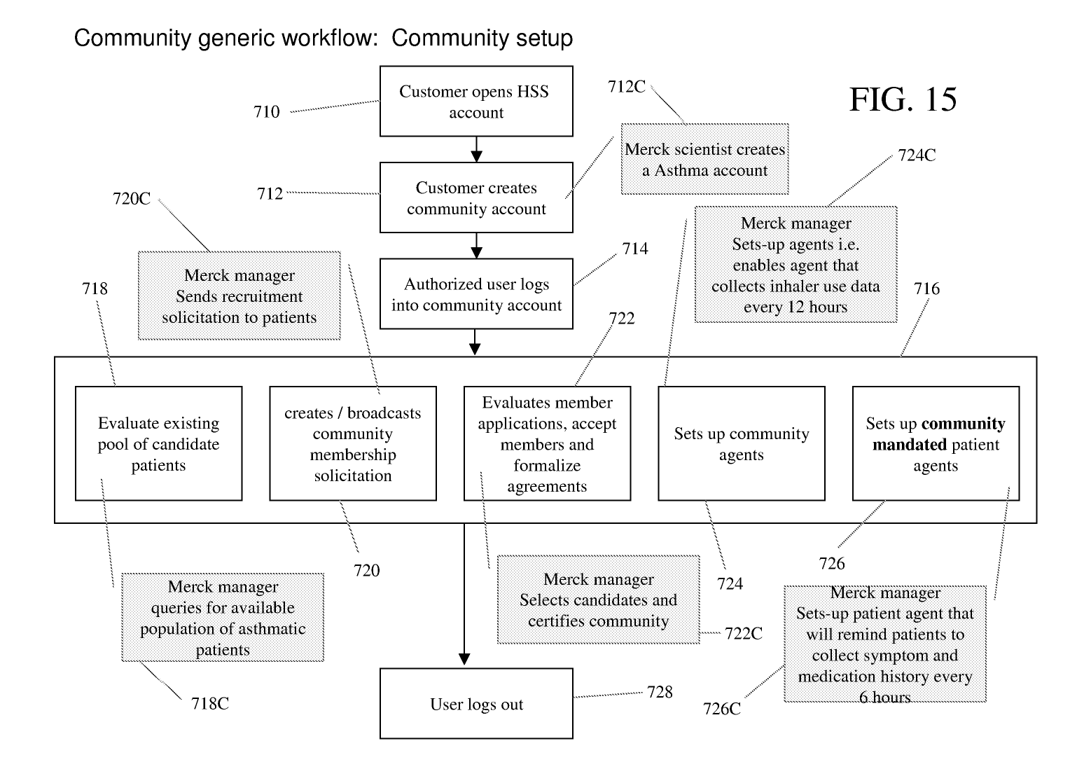

A process by which a customer (such as a corporate entity) sets up a community (discussed with respect to FIG. 5) within the context of the present invention is depicted in process flow form in FIG. 15. Comments 718C-726C refer to a specific example wherein company (Merck) is performing an asthma related study. According to 710, the customer opens an HSS (health service system) account utilizing tools made available by community manager 72. According to 712, the customer creates a community account. In the comment 712C example depicted in FIG. 15, the customer (Merck) creates an asthma research community account enabling data collection and analysis to be performed on behalf of a community of people having asthma.

According to 714, an authorized person (a user authorized by the customer) logs in to the account so as to perform one or more functions according to 716 utilizing tools provided by community manager 72. According to 718, the authorized person evaluates an existing pool of candidate patients to determine how best to establish the community definitions. In the comment 71 8C example, a customer queries the overall population for asthmatic patients.

According to 720 the authorized person creates and broadcasts a community membership solicitation. Potential candidates according to element 704 of FIG. 14 receive this solicitation. In the comment 720C example, a Merck manager sends recruitment solicitations to patients having asthma.

According to 722, the community subsystem 70 receives applications from potential candidates and then also according to 722 the authorized person accepts members and formalizes agreements. According to 724, the authorized person sets up community agents for the new community. In the case of the comment 724C example, a Merck manager sets up an agent that will seek to collect inhaler use data every 12 hours.

According to 726, the authorized person sets up community mandated patient agents. In the comment 726C example, one of these agents reminds patients to collect some information periodically. After taking one or more of the actions of 716, the authorized person logs out according to 728.

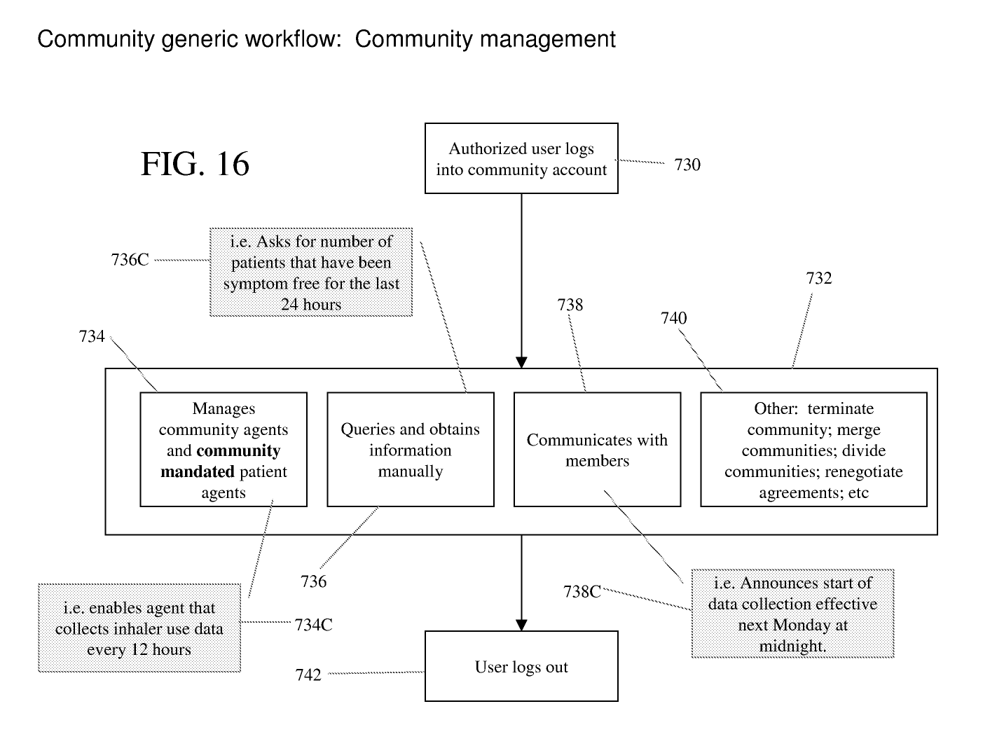

A process for managing a community is depicted in process flow diagram form in FIG. 16. The comments (734C-738C) refer to the specific Merck example from FIG. 15. According to 730 an authorized user logs into a community account (that has previously been set up pursuant to the discussion of FIG. 15). According to 732 the authorized user performs one or more functions 734-740.

According to 734 the authorized user manages community agents and/or community mandated patient agents. An example 734C would be an agent that assures that certain data is collected at a proper interval.

According to 736 the authorized user utilizes tools within community manager 72 to perform queries on the data collected for the relevant community. According to 738 the authorized person utilizes community subsystem 70 to communicate to the patients within the community.

According to 740 the authorized person may perform any number of misc. functions on the community—terminating the community, merging the community with another community, splitting the community into two or more communities, and/or renegotiate agreements with patients in the community.

According to 742 the authorized user logs out.

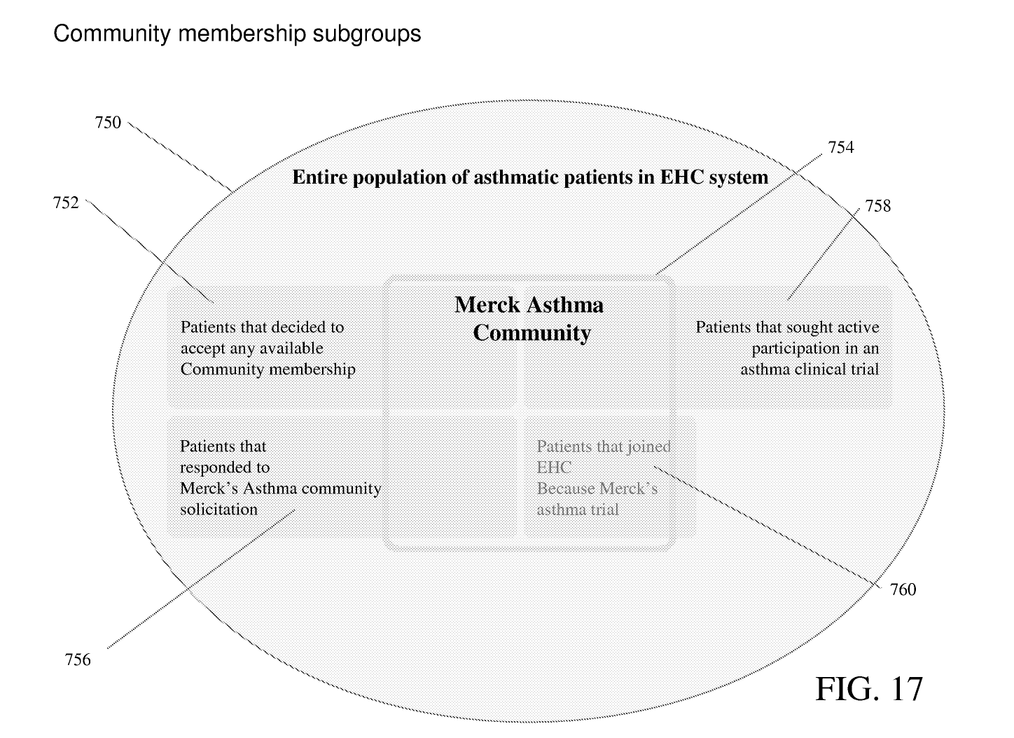

The concept of a community versus a greater population is depicted in FIG. 17. The greater population of patients having a certain characteristic in common (such as all having asthma) within EHC (the health service system) is depicted by element 750. Element 752 refers to the patients within that greater population that have accepted any available community membership related to that certain characteristic (such as those that have joined a asthma-related community within EHC). Within 754 are those who are part of the specific Merck asthma community.

Element 756 refers to those patients having the certain characteristic who have responded to a solicitation related to the characteristic (such as those who have responded to the exemplary Merck solicitation for asthma patients). A portion of these are within 754.

Element 758 refers to those patients who have sought active participation within a community (such as those who have sought active participation within the Merck Asthma trial). Again portions of those participate and are within 754. Element 760 refers to those patients who joined ECH in order to be part of a particular community such as the Merck asthma trial.

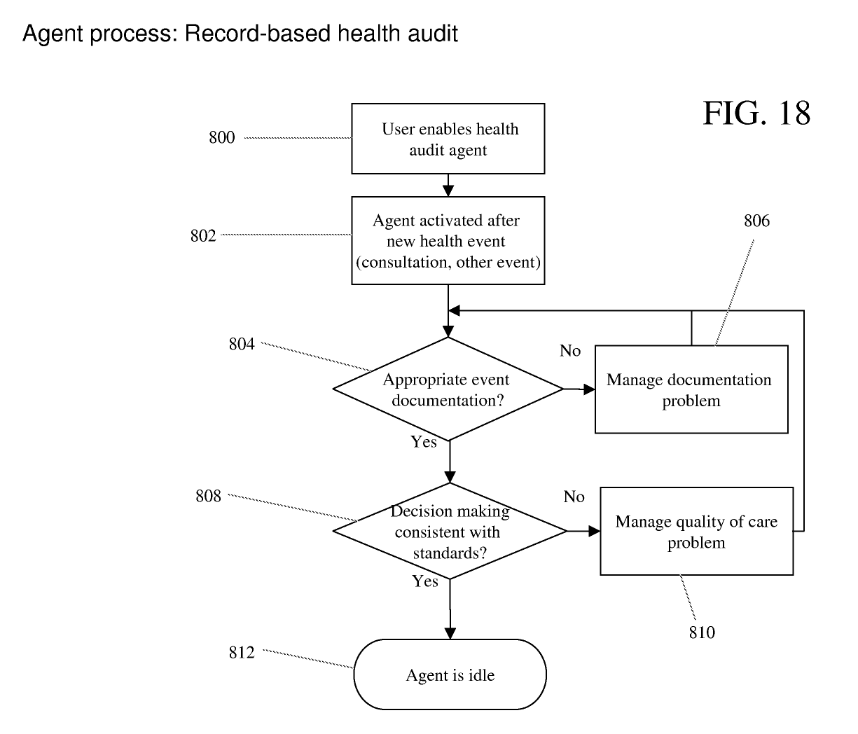

FIG. 18 depicts an agent for managing the quality of health services utilizing an audit process. Health service system 4 includes “standard information” defining standards to assure safety and effectiveness of health products and services.

According to 800, a user enables a health audit agent utilizing tools provided by agent manager 40 (FIG. 3). According to 802, the agent is activated based upon a “new health event” such as the patient receiving a health related service.

According to 804 the health audit agent checks to verify that proper documentation has been generated for the new health event. This documentation is necessary to assure that it can be ascertained as to whether the new health event was performed properly. If necessary, a documentation problem is managed or corrected according to 806.

Once the documentation has been verified to be sufficient then the health audit agent checks to make sure that the service has been performed pursuant to expected standards according to 808. An example of not meeting standards might be a health physical without including all the key diagnostic tests. If necessary the health audit agent manages assurance that standards are met according to 810. Once standards are met the agent can be come idle according to 812.

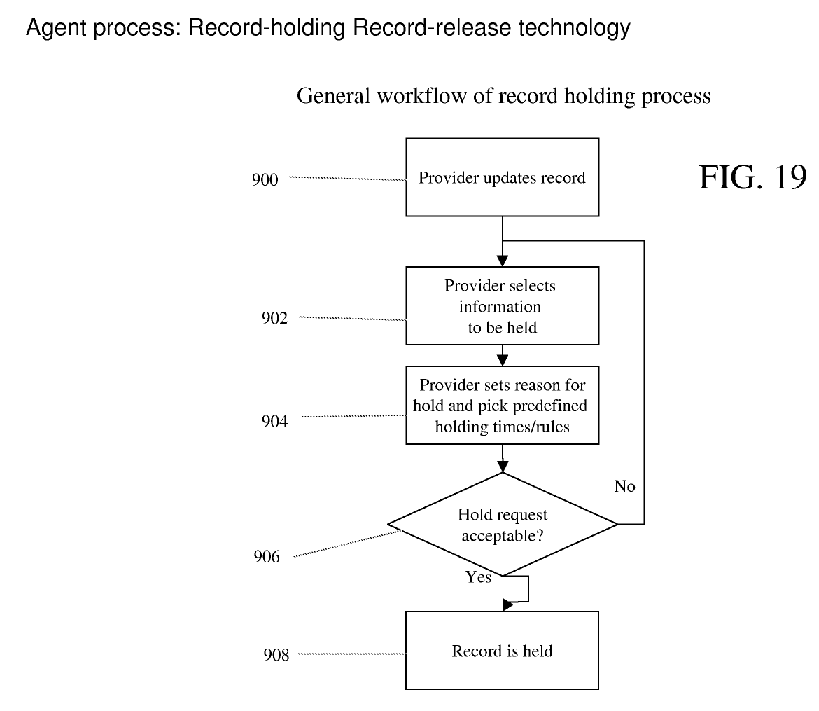

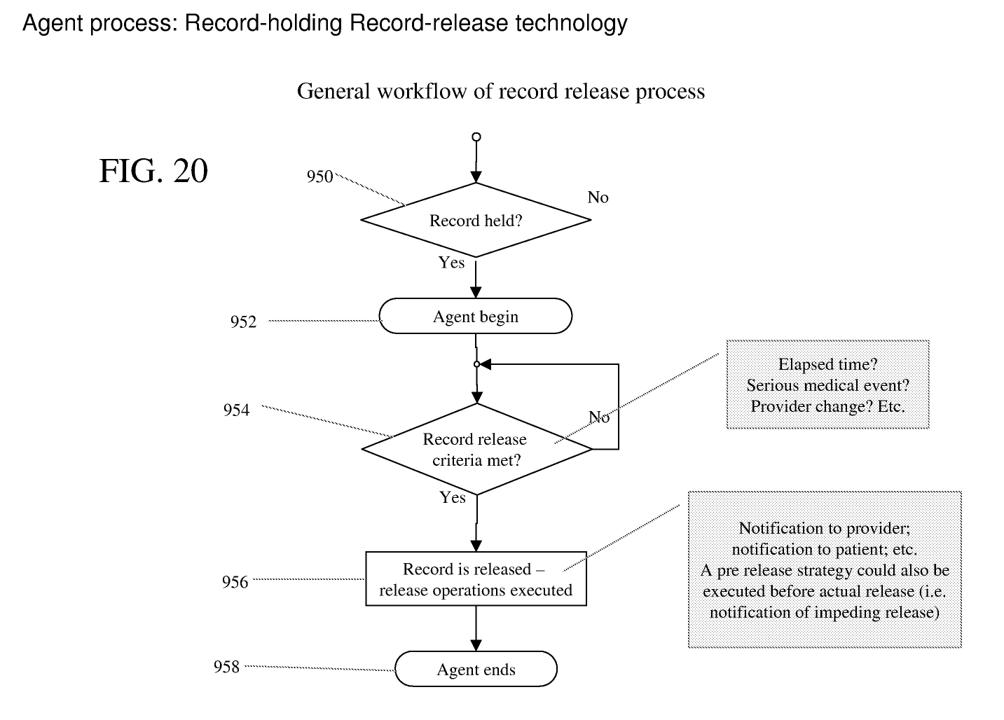

FIGS. 19 and 20 depicts an overall process of holding and releasing records to patients respectively. FIG. 19 depicts the process for initially holding health record information. According to 900 a provider may update a medical record within the health service system 4. According to 902 the provider may select some information to be held and not yet released to a system such as the patient system or another provider system.

According to 904 the provider sets a reason for the hold on the information and defines times and hold criteria determine under what conditions the information remains held. The hold criteria may be based on one or more of the following:
Time Elapsed Before Release of Information May Occur
A Date Code of When a Release of Information can Occur
A Health Event After Which Release of Information May Occur
A Health Consultation After Which Release of Information May Occur
A Change of Health Provider That May Trigger Information Release
Other Release Criteria
Rules Based on One or a Combination or a Modification of the Above

According to 906 the health service system checks to verify that the hold request is acceptable. If not then the provider must redefine the request. If so then the information is held according to 908.

FIG. 20 depicts the process for releasing the information to the patient. According to 950 a process occurs to determine whether information is being held. If so, then the release agent is activated according to 952.

According to 954 a test is performed to determine whether information release criteria have been met. If the release criteria have not been met then the agent loops back and continues testing.

If the criteria have been met then release operations are executed according to 956. At that point the agent is terminated according to 958.

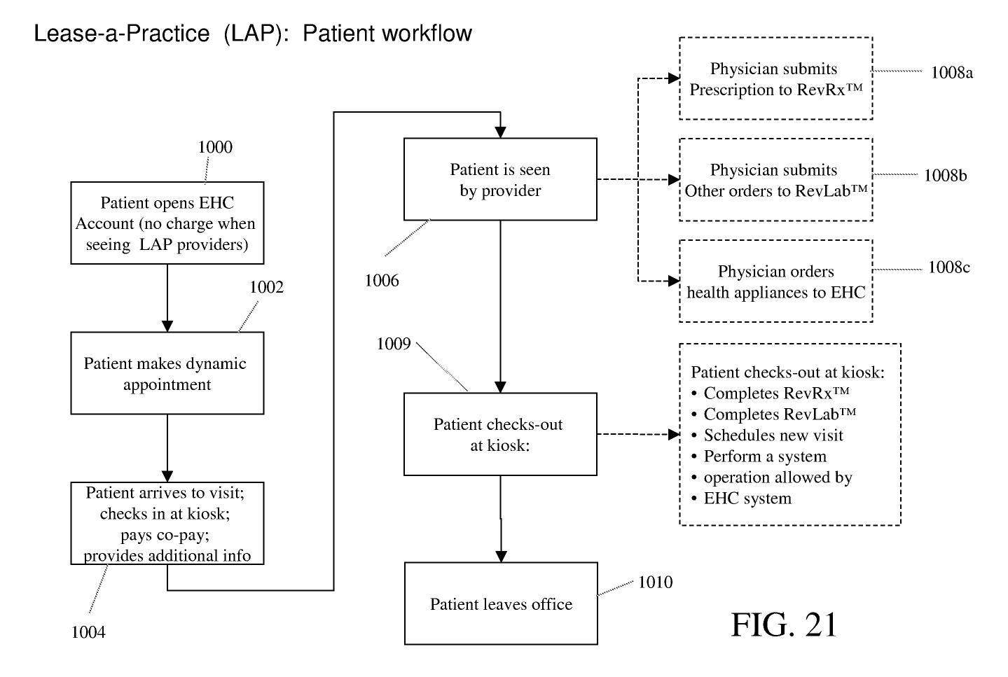

FIG. 21 depicts the utilization of multiple agents associated with a LAP (“lease a practice”) patient workflow that is at least partly enabled by health service system 4. LAP refers to a concept wherein an entity such as EHC (E-Health Communities™) provides portions of or all of a healthcare facility for a physician so that the physician can focus on the needs of patients and not have to be concerned with billing, equipment maintenance, etc.

According to 1000, a patient opens an account with EHC (the health service system of this invention). According to 1002 the patient utilizes an agent to set up an appointment. The process of setting up and holding the appointment according to 1002 may utilizes one or more of the methods described with respect to FIG. 9.

According to 1004 the patient arrives for an appointment and utilizes a kiosk (provided by EHC) to check in, provide a co-payment (if applicable), and provide information as necessary. The kiosk may be part of the provider system 18 and hence health service system receives check-in information from provider system 18. Then according to 1006 the physician sees the patient.

Optionally the physician utilizes one or more of agents 1008a-c according to the needs of the patient that become evident during the appointment. This may include an agent 1008a utilized to procure medication for the patient, an agent 1008b to submit lab orders for the patient, or an agent 1008c to order health appliances for the patient. Elements 1008a-1008c may utilize part or all of the processes described with respect to FIGS. 10 and/or 13.

After the appointment, the patient checks out at the kiosk according to 1009. Thus health service system receives checkout information from provider system 18. According to 1009 the checkout procedure may include completing an order for a prescription or service, scheduling a new appointment, etc.

The patient leaves the office according to 1010. Patient fact base 32 is updated based on the information generated during and as a result of the appointment described with respect to FIG. 21.

The agent depicted with respect to FIG. 18 may be executed to assure the quality of the services performed. Also, the agent depicted with respect to FIGS. 19-20 may also be executed if there is a need to put a hold on any health information generated as a result.

Within this approach to care, the patient and the physician benefit from the existence and utilization of patient and community facts and knowledge bases and from the activities performed by health agents.

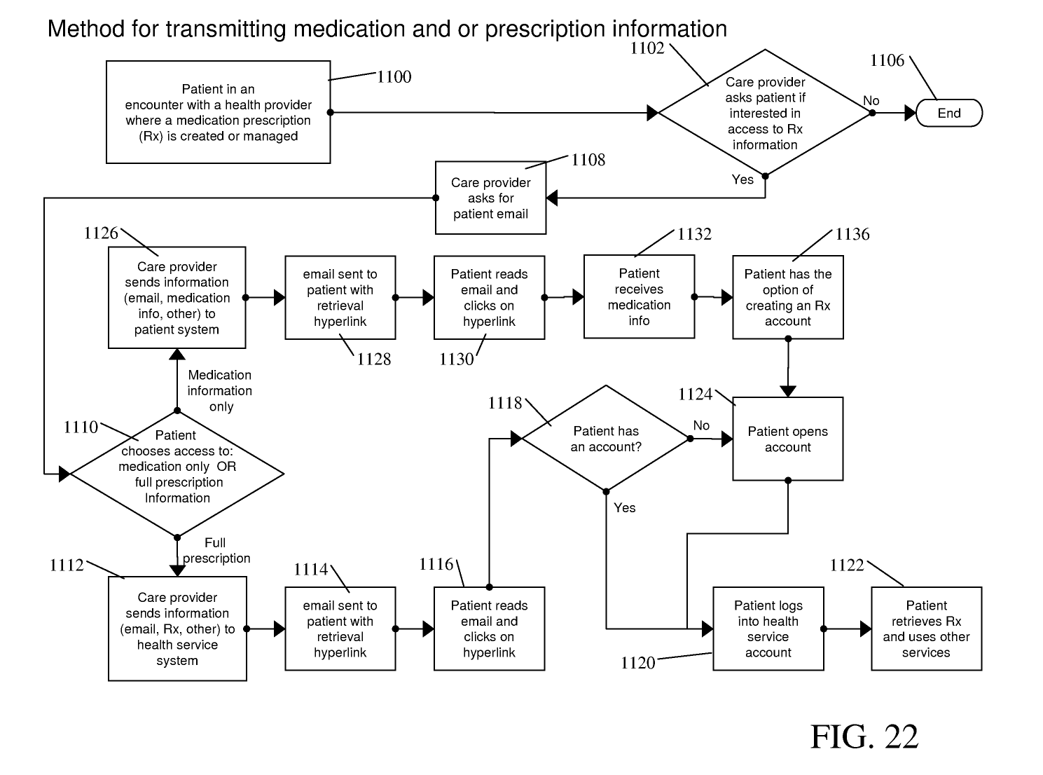

FIG. 22 depicts a process flow wherein a care provider (i.e. physician, pharmacist, nurse, etc) may help to provide medication information to a patient and to provide a method whereby the patent may gain access to the benefits of health service system 4. According to 1100, a patient participates in an encounter with a health provider where a medication prescription (Rx) is created or managed.

During the encounter, the care provider then inquires whether or not the patient is interested in additional information related to the Rx according to 1102. If the patient is not interested this process ends according to 1106.

According to 1108, the care provider asks the patient for an email address. According to 1110 the care provider asks the patient her preference concerning whether the information is non-confidential medication information only or full prescription information.

According to 1112, if the choice is to receive full prescription information, then the care provider system sends information including patient identifiable information to the health service system 4, specifically to the patient subsystem 30. According to 1114, the health service system 4 sends an email to the patient containing a unique retrieval hyperlink.

According to 1116 the patient uses his email system, reads the message from the health service system 4, and clicks on the unique retrieval hyperlink and opens a secure session with health service system 4. According to 1118, the patient can log on to health service system 4 to access the full prescription information or open a new account.

If the patient already has an account with health service system 4 then, according to 1120, the patient logs in. According to 1122, the secure patient subsystem 30 may then transfer the full prescription information and other information to patient system 16. According to 1122 the patient may also use other services of health service system 4. Other such services have been described with respect to earlier figures of this specification.

If according to 1118 the patient does not have an account with health service system 4, then according to 1124, the patient has an opportunity to open a new account. Once the account is opened, then the patient may proceed to login according to 1120 and can retrieve information and use other services according to 1122.

If according to 1126 the patient is only obtaining non-confidential medication information, then the care provider system sends information including patient identifiable information to the health service system 4. According to 1128, the health service system 4 sends an email to the patient containing a unique retrieval hyperlink.

According to 1130, the patient uses his email system, reads the message from the health service system 4, and clicks on the unique retrieval hyperlink and opens a secure session with health service system 4. According to 1132, the patient retrieves non-confidential information from the health service system 4. According to 1136, the patient is presented with the opportunity to open an account with the health service system 4.

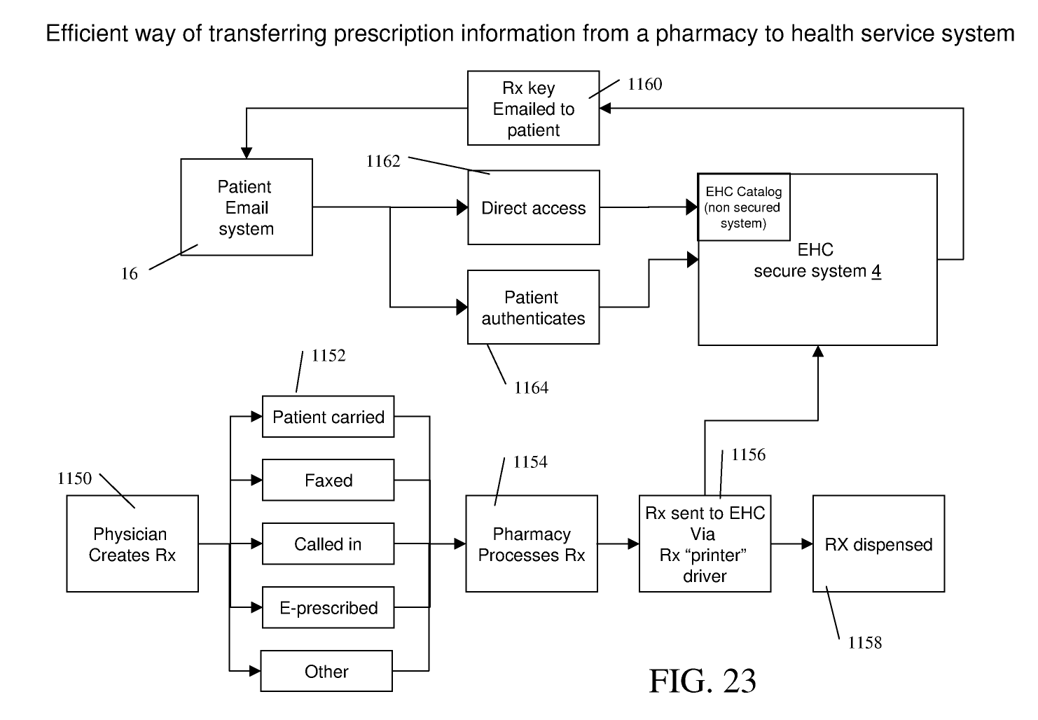

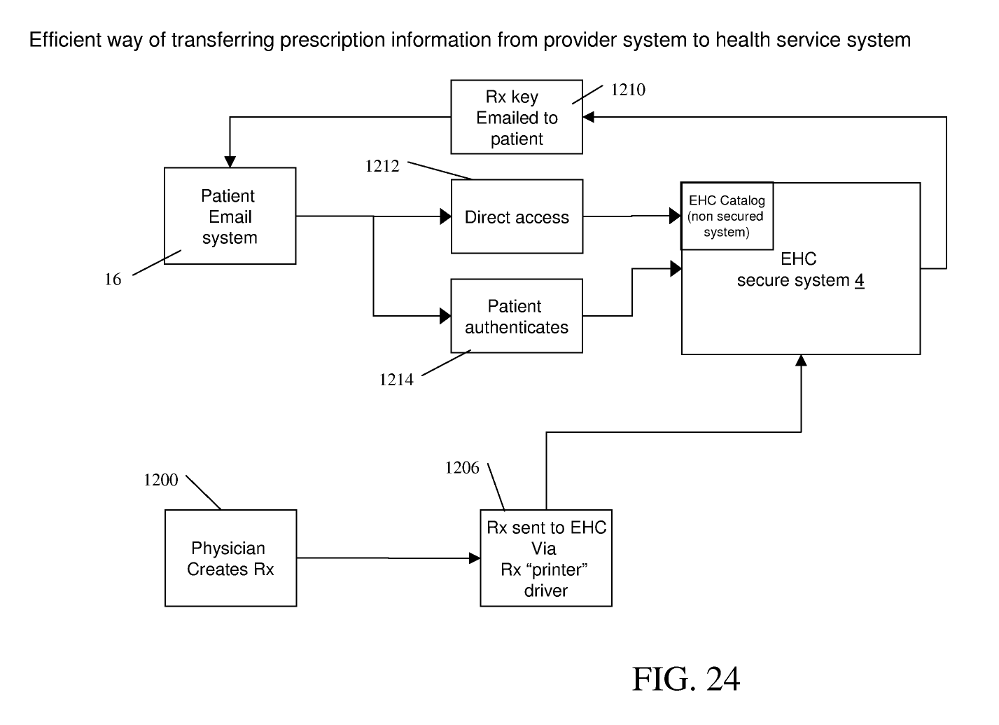

FIG. 23 is a process flow depiction of a very efficient way of transferring prescription information from a pharmacy to health service system 4. According to 1150 a physician creates an Rx (prescription) for a patient. According to 1152 the prescription is transferred to the pharmacy by one of some alternative means. According to 1154, the pharmacy processes the prescription. This may include steps such as verifying insurance, computing a co-pay, etc.

According to 1156, the prescription information is transferred from the pharmacy system 24 to a secure portion of health service system 4. In one particularly efficient method, the information defining the prescription is processed by the equivalent of a “printer driver” that then sends a “print file” to health service system 4. In such a case the pharmacy system 24 includes a software module (or modules) that can convert or parse the prescription information into standardized format.

According to 1158, the prescription is dispensed. Health service system 4 emails an “Rx key” to the patient system 16 according to 1160. This enables the patient to either obtain non-confidential information or confidential information from health service system 4. The patent may obtain non-confidential information from a non-secure portion of the health service system 4 by direct access according to 1162. Alternatively the patient may obtain the confidential prescription information from a secure portion of health service system 4 according to 1164 by utilizing the key received according to 1160.

FIG. 24 is a process flow depiction of a very efficient way of transferring prescription information from a provider system to health service system 4. According to 1200 a physician creates an Rx (prescription) for a patient. According to 1206, the prescription information is transferred from the provider system 18 to a secure portion of health service system 4. In one particularly efficient method, the information defining the prescription is processed by the equivalent of a “printer driver” that then sends a “print file” to health service system 4. In such a case the provider system 18 includes a software module (or modules) that can convert or parse the prescription information into standardized format.

Health service system 4 emails an “Rx key” to the patient system 16 according to 1210. This enables the patient to either obtain non-confidential information or confidential information from health service system 4. The patent may obtain non-confidential information from a non-secure portion of the health service system 4 by direct access according to 1212. Alternatively the patient may obtain the confidential prescription information from a secure portion of health service system 4 according to 1214 by utilizing the key received according to 1210.

What we claim is:

1. A health service system including:
a patient fact-base that stores health information including medical records for a patient;
a patient knowledge base that stores health knowledge for the patient that can be inferred at least in part from the health information; and
an agent subsystem configured to attain health goals for the patient.

2. The health service system of claim 1, wherein the agent subsystem is configured to utilize the health knowledge to attain the health goals for the patient.

3. The health service system of claim 1, wherein, as a result of the attaining the health goals for the patient, the agent subsystem is configured to update the patient fact-base.

4. The health service system of claim 1, wherein, as a result of the attaining the health goals for the patient, the agent subsystem is configured to update the patient knowledge base.

5. The health service system of claim 1 further comprising a patient subsystem configured to be under the control of a patient system operated by the patient and wherein the patient subsystem controls access to the patient fact-base and the patient knowledge base.

6. The health service system of claim 1 wherein the agent subsystem is configured to assure that the patient receives medical consultation.

7. The health service system of claim 1 wherein the agent subsystem is configured to assure that the patient receives a prescription.

8. The health service system of claim 1 wherein the agent subsystem is configured to assure that the patient receives an immunization.

9. The health service system of claim 1 wherein the agent audits a health event.

10. The health service system of claim 1 wherein the agent is configured to hold information from a health care provider and to release the information based upon criteria received from a patient system under control of a patient.

11. A method of increasing usable knowledge for a patient comprising:
providing a health service system including a patient fact-base that stores health records for a patient and a patient knowledge base that stores health knowledge information for the patient that can be inferred in part from the health records;
receiving a request from a patient subsystem to activate a software agent; and
based upon the request, executing an agent wherein the agent obtains a health goal for the patient.

12. The method of 11 further comprising updating the fact-base with information related to the health goal.

13. The method of 12 wherein agent is configured to assure that the patient receives a health consultation and wherein the information is a medical record generated during the consultation.

14. The method of 11 further comprising updating the knowledge base with information related to the health goal.

15. The method of claim 11 wherein the health goal is one of realizing an appointment with a practitioner, receiving a prescription, or receiving an immunization.

16. A health service system for a patient comprising:
a patient subsystem including a database holding patient health-related information that is configured to be accessed by a patient system that is under control of the patient; and
an agent subsystem configured to utilize the health-related information to accomplish a specific goal for the patient.

17. The health service system of claim 16 wherein the patient subsystem includes a patient fact base storing medical records and a patient knowledge base storing health knowledge.

18. The health service system of 16 wherein the agent subsystem includes a mandatory software agent that automatically executes when the patient initially establishes an account with the health service system.

19. The health service system of 16 wherein the agent subsystem includes an elective software agent that is configured to be selected by the patient.

20. The health service system of 16 wherein the agent subsystem includes a maintenance agent that is configured to maintain a health goal even after an initial goal of the agent is reached.
